(19) United States
(12) Patent Application Publication
(10) Pub. No.: US 2023/0133111 A1
(43) Pub. Date: May 4, 2023

(54) EPOXY RESIN COMPOSITION FOR PREPREG, AND PREPREG

(71) Applicant: The Yokohama Rubber Co., LTD., Tokyo (JP)

(72) Inventor: Mitsuhiro IWATA, Kanagawa (JP)

(21) Appl. No.: 17/759,425

(22) PCT Filed: Jan. 5, 2021
(86) PCT No.: PCT/JP2021/000086

§ 371 Date: Jan. 19, 2023

(30) Foreign Application Priority Data
Jan. 30, 2020 (JP) 2020-013690

(51) Int. Cl. C08G 59/24; C08G 59/40; C08K 3/36; C08L 51/04; C08K 7/14; C08L 71/12; C08J 5/24

(52) U.S. Cl. CPC C08G 59/245; C08G 59/4021; C08K 3/36; C08L 51/04; C08K 7/14; C08L 71/12; C08J 5/249; C08J 5/244; C08L 2207/53; C08K 2201/003; C08K 2201/011; C08J 2363/00

(57) ABSTRACT

The epoxy resin composition for a prepreg according to an embodiment of the present invention contains (A) an epoxy resin, (B) a curing agent or a curing accelerator, (C) silica microparticles, and (D) core-shell rubber particles, the epoxy resin composition containing from 1 to 5 parts by mass of (C) the silica microparticles and from 2 to 10 parts by mass of (D) the core-shell rubber particles per 100 parts by mass of (A) the epoxy resin, and a mass ratio of (C) the silica microparticles to (D) the core-shell rubber particles, in terms of (C)/(D), being from 1/1 to 1/5.

### TECHNICAL FIELD

The present technology relates to an epoxy resin composition for a prepreg and a prepreg.

### BACKGROUND ART

Fiber-reinforced composite materials containing a thermosetting resin such as an epoxy resin as a matrix have been known. For example, Japan Unexamined Patent Publication No. 2011-099094 describes an epoxy resin composition containing an epoxy resin as a matrix, a thermoplastic resin for viscosity adjustment, a filler, and a curing agent, and also describes a prepreg obtained by combining the composition and a reinforcing fiber.

However, there are problems in that viscosity adjustment of a known epoxy resin composition for a prepreg is difficult and, although such a known epoxy resin composition has a high viscosity at room temperature, the viscosity is lowered during curing and heating. Due to this problem, the resin composition flows out from the reinforcing fiber when the prepreg is heated and cured, and thus resin loss occurs in the resulting fiber-reinforced composite material and the thickness becomes uneven. To suppress the resin flow during curing, the viscosity of the resin composition needs to be increased; however, in this case, the viscosity of the resin composition at room temperature becomes too high, which causes deterioration of workability during prepreg formation.

### SUMMARY

The present technology provides an epoxy resin composition for a prepreg that can suppress resin flow during heat curing, that resolves resin loss and unevenness in thickness, and that has excellent workability, and a prepreg including the same.

The present technology includes blending a curing agent or a curing accelerator, silica microparticles, and core-shell rubber particles in an epoxy resin and specifying blended amounts of the silica microparticles and the core-shell rubber particles and a blending ratio of these.

An embodiment of the present technology provides an epoxy resin composition for a prepreg, the epoxy resin composition containing:

(A) an epoxy resin;

(B) a curing agent or a curing accelerator;

(C) silica microparticles; and

(D) core-shell rubber particles;

the epoxy resin composition containing, per 100 parts by mass of (A) the epoxy resin, from 1 to 5 parts by mass of (C) the silica microparticles and from 2 to 10 parts by mass of (D) the core-shell rubber particles, and

a mass ratio of (C) the silica microparticles to (D) the core-shell rubber particles, in terms of (C)/(D), being from 1/1 to 1/5.

According to an embodiment of the present technology, because (B) the curing agent or curing accelerator, (C) the silica microparticles, and (D) the core-shell rubber particles are blended in (A) the epoxy resin, and the blended amounts of the silica microparticles and the core-shell rubber particles and the blending ratio of these are specified, an epoxy resin composition for a prepreg that can suppress resin flow during heat curing, that can resolve resin loss and unevenness in thickness, and that has excellent workability, and a prepreg including this can be provided.

### DETAILED DESCRIPTION

Embodiments of the present technology will be described in further detail below.

### (A) Epoxy Resin

Examples of (A) the epoxy resin used in an embodiment of the present technology contains epoxy compounds having a bisphenyl group such as bisphenol A-type, bisphenol F-type, brominated bisphenol A-type, hydrogenated bisphenol A-type, bisphenol S-type, bisphenol AF-type, and bisphenyl-type epoxy compounds, polyalkylene glycol-type and alkylene glycol-type epoxy compounds, epoxy compounds having a naphthalene ring, bifunctional glycidyl ether-type epoxy resins such as epoxy compounds having a fluorene group; polyfunctional glycidyl ether-type epoxy resins such as phenol novolac-type, o-cresol novolac-type, trishydroxyphenylmethane-type, trifunctional, tetraphenylolethane-type glycidyl ether-type epoxy resins; glycidyl ester-type epoxy resins of synthetic fatty acid such as dimer acid, and glycidyl amine-type epoxy resins. Among these, although the reason is not clear, use of an epoxy resin containing no nitrogen atom can further enhance the effect of the present technology.

### (B) Curing Agent or Curing Accelerator

(B) The curing agent or curing accelerator used in an embodiment of the present technology is not particularly limited, and examples thereof include amine, acid anhydride, novolac resins, phenol, mercaptan, Lewis acid-amine complexes, onium salts, and imidazole.

### (C) Silica Microparticle

Examples of (C) the silica microparticles used in an embodiment of the present technology is preferably hydrophilic silica microparticles. Examples thereof include amorphous synthetic silica, such as precipitated silica, silica gel, pyrogenic silica, and molten silica; crystalline synthetic silica; and natural silica.

The form of the silica microparticle is not particularly limited, and examples thereof include spherical, granular, and irregular forms (fillers having an irregular or amorphous form). From the perspective of simultaneously satisfying heat resistance, toughness, and the viscosity characteristics described above, spherical, granular, and irregular forms are preferred.

As (C) the silica microparticles, commercially available silica microparticles can be appropriately selected. Examples thereof include CAB-O-SIL M5 (hydrophilic fumed silica) available from Cabot Corporation, and trade name: AEROSIL 200 (average particle diameter: 12 nm) available from Nippon Aerosil Co., Ltd.

The average particle diameter of (C) the silica microparticles is preferably from 5 to 100 nm, and more preferably 50 nm or less.

### (D) Core-Shell Rubber Particle

(D) The core-shell rubber particles used in an embodiment of the present technology can be known particles and, for example, a particle obtained by, on a surface of a particulate core component containing a crosslinked rubber-like polymer as a main component, graft-polymerizing a shell component polymer different from the core component can be employed.

Examples of the core component include butadiene rubber, acrylic rubber, silicone rubber, butyl rubber, NBR (nitrile rubber), SBR (styrene-butadiene rubber), IR (isoprene rubber), and EPR (ethylene propylene rubber).

Examples of the shell component include polymers obtained by polymerizing monomers selected from acrylate-based monomers, methacrylate-based monomers, and aromatic vinyl monomers.

The average particle diameter of (D) the core-shell rubber particles is, for example, from 10 nm to 10 μm, and preferably from 100 nm to 500 nm.

(D) The core-shell rubber particles can be appropriately selected from those commercially available, and examples thereof include MX-153 (epoxy resin (bisphenol A-type diglycidyl ether)/core-shell rubber particle master batch; containing 33 mass % of butadiene-based core-shell rubber particles; average particle diameter=100 to 200 nm), MX-154 (epoxy resin (bisphenol A-type diglycidyl ether)/core-shell rubber particle master batch; containing 40 mass % of butadiene-based core-shell rubber particles; average particle diameter=100 to 200 nm), and MX-257 (epoxy resin (bisphenol A-type diglycidyl ether)/core-shell rubber particle master batch; containing 37 mass % of butadiene-based core-shell rubber particles; average particle diameter=100 to 200 nm) available from Kaneka Corporation, and trade name: MX-125 (epoxy resin (bisphenol A-type diglycidyl ether)/core-shell rubber particle master batch; containing 25 mass % of SBR-based core-shell rubber particles; average particle diameter=100 to 200 nm) available from Kaneka Corporation.

Note that, in a case where the master batch described above is used, the epoxy resin contained therein is included in the amount of (A) the epoxy resin described above.

Note that the average particle diameter in an embodiment of the present technology refers to the average value of the equivalent circle diameter measured using an electron microscope, laser microscope, or the like and, for example, can be measured by the laser diffraction scattering particle size distribution analyzer LA-300 (available from Horiba, Ltd.) and laser microscope VK-8710 (available from Keyence Corporation).

In an embodiment of the present technology, a thermoplastic resin can be also blended as necessary.

Examples of the thermoplastic resin include polyethersulfone (PES), polyimide, polyetherimide (PEI), polyamide-imide, polysulfone, polycarbonate, polyether ether ketone, polyamides such as nylon 6, nylon 12, and amorphous nylon, aramid, arylate, polyester carbonate, and phenoxy resins.

Among these, from the perspective of further enhancing the viscosity characteristics, a phenoxy resin is preferred.

Blending Proportion

The epoxy resin composition for a prepreg according to an embodiment of the present technology contains from 1 to 5 parts by mass of (C) the silica microparticles and from 2 to 10 parts by mass of (D) the core-shell rubber particles per 100 parts by mass of (A) the epoxy resin, and a mass ratio of (C) the silica microparticles to (D) the core-shell rubber particles, in terms of (C)/(D), is from 1/1 to 1/5.

When the blending proportion of (C) the silica microparticles is less than 1 part by mass or the blending proportion of (D) the core-shell rubber particles is less than 2 parts by mass, suppression of resin flow during heat curing is insufficient, and the effects of the present technology cannot be exhibited.

When the blending proportion of (C) the silica microparticles is more than 5 parts by mass, the viscosity of the resin composition at room temperature becomes excessively high, and workability during prepreg formation is deteriorated.

When the blending proportion of (D) the core-shell rubber particles is more than 10 parts by mass, suppression of resin flow during heat curing is insufficient, and mechanical strength of the formed prepreg becomes insufficient.

When the mass ratio of (C) the silica microparticles to (D) the core-shell rubber particles, in terms of (C)/(D), is more than 1/1, that is, when the blended amount of the (D) component is smaller with respect to the amount of the (C) component, suppression of resin flow during heat curing is insufficient, and the effects of the present technology cannot be exhibited.

When the mass ratio of (C) the silica microparticles to (D) the core-shell rubber particles, in terms of (C)/(D), is less than 1/5, that is, when the blended amount of the (D) component is excessively large with respect to the (C) component, the viscosity of the resin composition at room temperature becomes excessively high, and workability during prepreg formation is deteriorated.

Furthermore, (B) the curing agent or curing accelerator may be blended in an appropriate amount based on the type of the curing agent, and the amount thereof can be easily decided by one skilled in the art.

In an embodiment of the present technology, the blended amount of (C) the silica microparticles is more preferably from 2 to 4 parts by mass per 100 parts by mass of (A) the epoxy resin, the blended amount of (D) the core-shell rubber particles is more preferably from 4 to 8 parts by mass, and the mass ratio of (C) the silica microparticles to (D) the core-shell rubber particles, in terms of (C)/(D), is more preferably from 1/1.5 to 1/4.

In a case where a thermoplastic resin is used, the blended amount thereof is preferably from 5 to 50 parts by mass, and more preferably from 10 to 30 parts by mass, per 100 parts by mass of (A) the epoxy resin.

Because the epoxy resin composition for a prepreg of an embodiment of the present technology has tan δ at 1% strain of less than 1 and tan δ at 100% strain of more than 1 when viscoelasticity is measured at a temperature of 70° C. and a frequency of 1 Hz using parallel plates, resin flow during heat curing is suppressed, resin loss and unevenness in thickness are less likely to occur, and workability becomes particularly excellent. Note that the measurement of viscoelasticity can be performed by using, for example, trade name: ARES, available from TA Instruments. Furthermore, the viscoelasticity can be achieved by appropriately setting the blended amounts of (C) the silica microparticles and (D) the core-shell rubber particles with respect to the amount of (A) the epoxy resin in the ranges described above.

The epoxy resin composition for a prepreg of an embodiment of the present technology may contain other additives as necessary. Examples of the additives include fillers, anti-aging agents, solvents, flame retardants, reaction retarders, antioxidants, pigments (dyes), plasticizers, thixotropic agents, UV (ultraviolet) absorbents, surfactants (including leveling agents), dispersants, dehydrating agents, adhesion promoters, and antistatic agents.

The prepreg of an embodiment of the present technology is formed of the epoxy resin composition for a prepreg of an embodiment of the present technology and a reinforcing fiber. Since the prepreg of an embodiment of the present technology is formed of the epoxy resin composition for a prepreg of an embodiment of the present technology and a reinforcing fiber, resin loss and unevenness in thickness are also suppressed, and thus excellent mechanical strength is achieved.

Specifically, the prepreg of an embodiment of the present technology is obtained by impregnating reinforcing fiber with the epoxy resin composition for a prepreg of an embodiment of the present technology.

The reinforcing fiber used in the prepreg of an embodiment of the present technology is not particularly limited, and examples thereof include known products. Of these, from the perspective of strength, the reinforcing fiber is preferably at least one selected from the group consisting of carbon fibers, glass fibers, and aramid fibers.

The form of the fiber is not particularly limited, and examples thereof include roving, a material in which rovings are aligned in one direction, fabric, nonwoven fabric, knitted fabric, and tulle.

A method of manufacturing the prepreg of an embodiment of the present technology is not particularly limited. Examples thereof include wet methods using a solvent and hot-melt methods (solvent-free methods). From the perspective of being able to reduce drying time, the amount of the solvent used is preferably from 80 to 200 parts by mass per 100 parts by mass of the solid content of the epoxy resin composition for a prepreg.

From the perspective of mechanical characteristics of the resulting fiber-reinforced composite material, the content of the epoxy resin composition for a prepreg in the prepreg of an embodiment of the present technology is preferably from 30 to 60 mass % in the prepreg.

Use of the prepreg of an embodiment of the present technology is not particularly limited. For example a known fiber-reinforced composite material can be obtained by curing the prepreg of an embodiment of the present technology. Specific examples of uses include aircraft parts (e.g., fairings, flaps, leading edges, floor panels, propellers, fuselages, and the like); two-wheel vehicle parts (e.g., motorcycle frames, cowls, fenders, and the like); automobile parts (e.g., doors, bonnets, tailgates, side fenders, side panels, fenders, energy absorbers, trunk lids, hard tops, side mirror covers, spoilers, diffusers, ski carriers, engine cylinder covers, engine hoods, chassis, air spoilers, propeller shafts, and the like); vehicle exterior plating (e.g., lead car noses, roofs, side panels, doors, truck bed covers, side skirts, and the like); railroad vehicle parts (e.g., luggage racks, seats, and the like); aero parts (e.g., side skirts and the like mounted on automobiles and rigid vehicles such as interior design elements, inner panels, outer panels, roofs, and floors of wings on wing trucks, and the like); use as housings (e.g., notebook computers, portable phones, and the like); medical uses (e.g., X-ray cassettes, table tops, and the like); audio product uses (e.g., flat speaker panels, speaker cones, and the like); sports goods uses (e.g., golf club heads, face masks, snowboards, surf boards, protectors, and the like); and general industrial uses (e.g., flat springs, windmill blades, and elevators (compartment panels, doors).

Additionally, a fiber-reinforced composite material can be fabricated by layering the prepreg of an embodiment of the present technology and another member (e.g., a honeycomb core). Examples of the fiber-reinforced composite material that can be fabricated by layering the prepreg of an embodiment of the present technology and another member include honeycomb sandwich panels.

### Example

The present technology will be described in further detail by way of examples and comparative examples, but the present technology is not limited by these examples.

In the following examples, the following materials were used.

(A) Epoxy resin 1: YD-128, available from Nippon Steel & Sumikin Chemical Co., Ltd. (bisphenol A-type diglycidyl ether (DEGBA); viscosity at 25° C.=10000 to 15000 mPa·s);

(A) Epoxy resin 2: YD-014, available from Nippon Steel & Sumikin Chemical Co., Ltd. (bisphenol A-type diglycidyl ether (DEGBA); softening point: 100° C.)

(B) Curing agent: DICY-15, available from Mitsubishi Chemical Corporation (dicyandiamide)

(B) Curing accelerator: OMICURE 24, available from CVC Thermoset Specialties (urea)

(C) Silica microparticles: CAB-O-SIL M5, available from Cabot Corporation (hydrophilic fumed silica)

(C) Silica microparticles: AEROSIL 200, available from Nippon Aerosil Co., Ltd. (hydrophilic fumed silica)

(D) Core-shell rubber particles: MX-153, available from Kaneka Corporation (bisphenol A-type diglycidyl ether (DEGBA)/core-shell rubber particle master batch; containing 33 mass % of butadiene-based core-shell rubber particles)

(D) MX-154, available from Kaneka Corporation (bisphenol A-type diglycidyl ether (DEGBA)/core-shell rubber particle master batch; containing 40 mass % of butadiene-based core-shell rubber particles; average particle diameter=100 to 200 nm)

(D) MX-257, available from Kaneka Corporation (epoxy resin (bisphenol A-type diglycidyl ether)/core-shell rubber particle master batch; containing 37 mass % of butadiene-based core-shell rubber particles; average particle diameter=100 to 200 nm)

(D) Trade name: MX-125, available from Kaneka Corporation (bisphenol A-type diglycidyl ether (DEGBA)/core-shell rubber particle master batch; containing 25 mass % of SBR-based core-shell rubber particles; average particle diameter=100 to 200 nm)

Thermoplastic resin: YP-75, available from NIPPON STEEL Chemical & Material Co., Ltd. (phenoxy resin)

According to the blending proportions (parts by mass) listed in Table 1 below, the materials were kneaded at 70° C. by using a kneader, and thus each epoxy resin composition for a prepreg was prepared.

The following measurements were performed for the obtained epoxy resin compositions for a prepreg.

Viscoelasticity: By using ARES, available from TA Instruments, tan δ at 1% or 100% strain was measured at a temperature of 70° C. and a frequency of 1 Hz using parallel plates.

### Formation of Prepreg

A glass fiber fabric (fiber basis weight: 156 g/m²) was impregnated with the epoxy resin composition film for a prepreg (resin weight: 104 g/m²), and thus a prepreg was formed. The epoxy resin composition for a prepreg in the formed prepreg was 40 mass %.

Workability: Workabilities at the time of preparing the epoxy resin composition film for a prepreg and at the time of infiltration into the glass fiber fabric were evaluated based on the following criteria.

Good: Film preparation was good, and infiltration into glass fiber fabric was good

Poor: Film preparation was difficult, and thus prepreg could not be formed

Dimensional stability: 10 sheets of prepregs cut into 300 mm×300 mm were layered and cured at 120° C. for 2 hours in an autoclave, and the thickness of the obtained fiber-reinforced composite material was measured.

The evaluation was performed based on the following evaluation criteria.

Good: The difference between the maximum thickness and the minimum thickness was 5% or less of the maximum thickness, and formability (dimensional stability) was good.

Poor: The difference between the maximum thickness and the minimum thickness was more than 5% of the maximum thickness, and formability (dimensional stability) was poor.

Resin flow during curing: 6 sheets of prepregs cut into 100 mm×100 mm were layered and pressed by being sandwiched together with a metal spacer having a thickness of 0.8 mm in between metal plates at a pressure of 3 kgf/cm² and at 150° C. for 5 minutes, then the weight of the resin cured product pressed out from the fiber was measured, and the resin flow was calculated by the following equation.

Resin flow (%)=(weight of resin cured product pressed out)/(weight of laminate before pressing)×100

The evaluation was performed based on the following evaluation criteria.

Good: 6 to 10%

Poor: not “good” described above (In a case where resin flow was small, no loss occurred in the formed product, but the predetermined thickness was not obtained (pressing was not performed to the thickness of the spacer). In a case where resin flow was a lot, loss occurred in the formed product, and the thickness was uneven)

The results are shown in Table 1.

TABLE 1-1
(parts by mass)

| | Product | | Example | Example | Example | Example |
|---|---|---|---|---|---|---|
| Material | name | Details | 1 | 2 | 3 | 4 |
| (A) Epoxy resin | YD-128 | DEGBA | 68 | 69 | 68.2 | 56 |
| | YD-014 | DEGBA (solid) | 20 | 25 | 25 | 20 |
| Thermoplastic resin | YP-75 | Phenoxy resin | 20 | 20 | 20 | 20 |
| (B) Curing agent or | DICY-15 | Dicyandiamide | 5 | 5 | 5 | 5 |
| curing accelerator | | | | | | |
| (B) Curing agent or | OMICURE | Urea | 5 | 5 | 5 | 5 |
| curing accelerator | 24 | | | | | |
| (C) Silica | CAB-O- | Silica | 3 | 2 | 1 | 3 |
| microparticles | SIL M5 | microparticles | | | | |
| (C) Silica | AEROSIL | Silica | — | — | 2 | — |
| microparticles | 200 | microparticles | | | | |
| (D) Core-shell | MX-153 | DEGBA/BR | 18(6) | — | — | — |
| rubber particles | | (33%) | | | | |
| (core-shell rubber | | | | | | |
| particles in (D)) | | | | | | |
| (D) Core-shell | MX-154 | DEGBA/BR | — | 10(4) | — | — |
| rubber particles | | (40%) | | | | |
| (core-shell rubber | | | | | | |
| particles in (D)) | | | | | | |
| (D) Core-shell | MX-257 | DEGBA/BR | — | — | 10.8(4) | — |
| rubber particles | | (37%) | | | | |
| (core-shell rubber | | | | | | |
| particles in (D)) | | | | | | |
| (D) Core-shell | MX-125 | DEGBA/SBR | — | — | — | 32(8) |
| rubber particles | | (25%) | | | | |
| (core-shell rubber | | | | | | |
| particles in (D)) | | | | | | |
| Viscoelasticity (1% | — | — | 0.4 | 0.3 | 0.5 | 0.7 |
| strain) | | | | | | |
| Viscoelasticity | — | — | 1.3 | 2.7 | 1.5 | 2.3 |
| (100% strain) | | | | | | |
| Workability | — | — | Good | Good | Good | Good |
| Dimensional stability | — | — | Good | Good | Good | Good |
| Resin flow | — | — | Good | Good | Good | Good |

TABLE 1-2
(parts by mass)

| | Product | | Example | Example | Comparative | Comparative |
|---|---|---|---|---|---|---|
| Material | name | Details | 5 | 6 | Example 1 | Example 2 |
| (A) Epoxy | YD-128 | DEGBA | 60 | 59 | 75 | 75 |
| resin | YD-014 | DEGBA (solid) | 20 | 35 | 25 | 25 |
| Thermoplastic | YP-75 | Phenoxy resin | 20 | — | 25 | 20 |
| resin | | | | | | |
| (B) Curing | DICY-15 | Dicyandiamide | 5 | 5 | 5 | 5 |
| agent or curing | | | | | | |
| accelerator | | | | | | |
| (B) Curing | OMICURE | Urea | 5 | 5 | 5 | 5 |
| agent or curing | 24 | | | | | |
| accelerator | | | | | | |
| (C) Silica | CAB-O- | Silica | — | 2 | — | — |
| microparticles | SIL M5 | microparticles | | | | |
| (C) Silica | AEROSIL | Silica | 4 | — | — | 8 |
| microparticles | 200 | microparticles | | | | |
| (D) Core-shell | MX-153 | DEGBA/BR | 30(10) | — | — | — |
| rubber particles | | (33%) | | | | |
| (core-shell | | | | | | |
| rubber particles | | | | | | |
| in (D)) | | | | | | |
| (D) Core-shell | MX-154 | DEGBA/BR | — | 10(4) | — | — |
| rubber particles | | (40%) | | | | |
| (core-shell | | | | | | |
| rubber particles | | | | | | |
| in (D)) | | | | | | |
| (D) Core-shell | MX-257 | DEGBA/BR | — | — | — | — |
| rubber particles | | (37%) | | | | |
| (core-shell | | | | | | |
| rubber particles | | | | | | |
| in (D)) | | | | | | |
| (D) Core-shell | MX-125 | DEGBA/SBR | — | — | — | — |
| rubber particles | | (25%) | | | | |
| (core-shell | | | | | | |
| rubber particles | | | | | | |
| in (D)) | | | | | | |
| Viscoelasticity | — | — | 0.9 | 0.3 | 36.3 | 1.9 |
| (1% strain) | | | | | | |
| Viscoelasticity | — | — | 1.7 | 2.2 | 34.2 | 2.0 |
| (100% strain) | | | | | | |
| Workability | — | — | Good | Good | Good | Poor |
| Dimensional | — | — | Good | Good | Poor | Poor |
| stability | | | | | | |
| Resin flow | — | — | Good | Good | Poor | Poor |

TABLE 1-3
(parts by mass)

| | | | Comparative | Comparative | Comparative |
|---|---|---|---|---|---|
| Material | Product name | Details | Example 3 | Example 4 | Example 5 |
| (A) Epoxy resin | YD-128 | DEGBA | 60 | 55 | 45 |
| | YD-014 | DEGBA (solid) | 20 | 25 | 25 |
| Thermoplastic resin | YP-75 | Phenoxy resin | 25 | 20 | 20 |
| (B) Curing agent or curing accelerator | DICY-15 | Dicyandiamide | 5 | 5 | 5 |
| (B) Curing agent or curing accelerator | OMICURE 24 | Urea | 5 | 5 | 5 |
| (C) Silica microparticles | CAB-O-SIL M5 | Silica microparticles | — | — | — |
| (C) Silica microparticles | AEROSIL 200 | Silica microparticles | — | 1.5 | 5 |
| (D) Core-shell rubber particles (core- | MX-153 | DEGBA/BR (33%) | 30(10) | 30(10) | 45(15) |
| shell rubber particles in (D)) | | | | | |
| (D) Core-shell rubber particles (core- | MX-154 | DEGBA/BR (40%) | — | — | — |
| shell rubber particles in (D)) | | | | | |
| (D) Core-shell rubber particles (core- | MX-257 | DEGBA/BR (37%) | — | — | — |
| shell rubber particles in (D)) | | | | | |
| (D) Core-shell rubber particles (core- | MX-125 | DEGBA/SBR (25%) | — | — | — |
| shell rubber particles in (D)) | | | | | |
| Viscoelasticity (1% strain) | — | — | 3.3 | 3.4 | 0.6 |
| Viscoelasticity (100% strain) | — | — | 2.5 | 3.9 | 0.9 |
| Workability | — | — | Good | Good | Poor |
| Dimensional stability | — | — | Poor | Good | Good |
| Resin flow | — | — | Poor | Poor | Poor |

From the results of Table 1, it was found that the epoxy resin composition for a prepreg of each of Examples, in which (B) the curing agent or curing accelerator, (C) the silica microparticles, and (D) the core-shell rubber particles were added to (A) the epoxy resin and the blending proportions of (C) the silica microparticles and (D) the core-shell rubber particles with respect to (A) the epoxy resin were specified in the ranges defined in an embodiment of the present technology, was able to suppress resin flow during heat curing, resolve resin loss and unevenness in the thickness, and achieve excellent workability. Furthermore, because the epoxy resin composition for a prepreg of each of Examples had tan δ at 1% strain of less than 1 and tan δ at 100% strain of more than 1 when viscoelasticity was measured at a temperature of 70° C. and a frequency of 1 Hz using parallel plates, the epoxy resin composition had low strain and was solid-like (tan δ<1) and was able to suppress resin flow during heat curing, and also had high strain and was liquid-like (tan δ>1), and exhibited excellent workability during film application or infiltration.

On the other hand, Comparative Example 1 had poor results for the dimensional stability and the resin flow during curing because (C) the silica microparticles and (D) the core-shell rubber particles were not added.

Comparative Example 2 had poor results for the workability, the dimensional stability, and the resin flow during curing because the added amount of (C) the silica microparticles was more than the upper limit defined in an embodiment of the present technology and (D) the core-shell rubber particles were not added.

Comparative Example 3 had poor results for the dimensional stability and the resin flow during curing because (C) the silica microparticles were not added.

Comparative Example 4 had poor result for the resin flow during curing because (C)/(D) described above was not in the range of an embodiment of the present technology.

Comparative Example 5 had poor results for the workability and the resin flow during curing because the added amount of (D) the core-shell rubber particles was more than the upper limit defined in an embodiment of the present technology.

1. An epoxy resin composition for a prepreg, the epoxy resin composition comprising:
(A) an epoxy resin;
(B) a curing agent or a curing accelerator;
(C) silica microparticles; and
(D) core-shell rubber particles;
the epoxy resin composition comprising, per 100 parts by mass of (A) the epoxy resin, from 1 to 5 parts by mass of (C) the silica microparticles and from 2 to 10 parts by mass of (D) the core-shell rubber particles, and
a mass ratio of (C) the silica microparticles to (D) the core-shell rubber particles, in terms of (C)/(D), being from 1/1 to 1/5.

2. The epoxy resin composition for a prepreg according to claim 1, wherein, when viscoelasticity is measured at a temperature of 70° C. and a frequency of 1 Hz using parallel plates, tan δ at 1% strain is less than 1 and tan δ at 100% strain is more than 1.

3. The epoxy resin composition for a prepreg according to claim 1, wherein (A) the epoxy resin does not contain a nitrogen atom.

4. The epoxy resin composition for a prepreg according to claim 1, wherein an average particle diameter of (C) the silica microparticles is from 5 nm to 100 nm.

5. The epoxy resin composition for a prepreg according to claim 1, wherein an average particle diameter of (D) the core-shell rubber particles is from 10 nm to 10 μm.

6. The epoxy resin composition for a prepreg according to claim 1, the epoxy resin composition further comprising from 5 to 50 parts by mass of a thermoplastic resin per 100 parts by mass of (A) the epoxy resin.

7. The epoxy resin composition for a prepreg according to claim 6, wherein the thermoplastic resin is a phenoxy resin.

8. A prepreg comprising the epoxy resin composition for a prepreg according to claim 1 and a reinforcing fiber.
